(19) United States
(12) Patent Application Publication
(10) Pub. No.: US 2006/0233594 A1
(43) Pub. Date: Oct. 19, 2006

(54) Applicator for liquid cosmetic compositions

(76) Inventor: Gregory Alan Erickson, Chicago, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/542,425

(22) PCT Filed: Dec. 17, 2003
(86) PCT No.: PCT/EP03/14493

§ 371 Date: Apr. 25, 2006

(30) Foreign Application Priority Data
Jan. 14, 2003 (EP) 03250205.6

(51) Int. Cl. B43K 8/06; B43M 11/06

(52) U.S. Cl. 401/198

(57) ABSTRACT

A product comprising a liquid cosmetic composition (3) and a device (14) for applying the same, said device (14) comprising a porous polymeric applicator head (1), an absorbent material (2) fixed in intimate contact therewith, and a reservoir (4) for the liquid cosmetic composition (3) from which said composition is delivered to the absorbent material (2), characterised in that the total capacity of the absorbent material (2) for the liquid cosmetic composition (3) is less than the amount of liquid cosmetic composition (3) that may be held in the reservoir (4).

The present invention is in the field of cosmetic product application, in particular the application of liquid cosmetic compositions to the human body and devices for doing the same.

Devices for applying cosmetic compositions to the body may be broadly divided into two types: contact applicators and non-contact applicators (e.g. spray applicators). The present invention is concerned with the former type of applicator, in particular contact applicators for liquid cosmetic compositions. A commonly used device for contact application of liquid cosmetic compositions is the roll-on applicator, where the liquid composition is applied from a rotatable ball which contacts the liquid composition on the inside of the applicator and, in use, rotates and transfers it to the consumer's body on the outside of the ball.

As a method of applying a liquid cosmetic composition, roll-on applicators have a number of disadvantages. In particular, the ball may have a tendency to seize and the sensory properties are perceived as poor by some users. These problems may be overcome by the use of a device having a porous polymeric plastic applicator surface; examples of such devices are described in GB 2,084,455, U.S. Pat. No. 4,384,589, U.S. Pat. No. 4,480,940, EP 155,349 B1, U.S. Pat. No. 4,936,700, and U.S. Pat. No. 5,073,057. Other similar devices are disclosed in DE 39,38,347 A1, DE 88,03,017 U, and US 2002/0094225 A1.

Other fluid dispensing utensils, in particular writing utensils, are disclosed in WO 98/21052, U.S. Pat. No. 6,322,268 B1 and U.S. Pat. No. 6,632,041 B1.

Devices having a porous polymeric plastic applicator surface may themselves have problems associated with their use. In particular, there can be problems with the delivery of the liquid composition to the applicator surface. For example, in simple devices, contact of the liquid composition with the applicator head is orientation dependent. This can lead to delayed wetting of the applicator head, if the device is not suitably orientated prior to use. A further problem with such devices is that there is no regulation of the flow of the liquid composition to the applicator surface and this can lead to leakage and/or over-application of the composition. Delivery that is regulated and yet sufficient, in terms of total amount and/or rate, is desired from high performing cosmetic applicators.

It has been suggested in many of the above citations that the liquid composition be absorbed onto an absorbent material in intimate contact with the porous polymeric plastic applicator head. The absorbent material can serve to regulate the flow of the liquid composition to the applicator surface, thereby reducing the problems of unregulated flow referred to above. In addition, when the absorbent material is fixed in intimate contact with the applicator head, problems associated with orientation effects are reduced or even eliminated.

In a first aspect of the present invention there is provided a product comprising a liquid cosmetic composition and a device for applying the same, said device comprising a porous polymeric applicator head, an absorbent material fixed in intimate contact therewith, and a reservoir for the liquid cosmetic composition from which said composition is delivered to the absorbent material, characterised in that the total capacity of the absorbent material for the liquid cosmetic composition is less than the amount of liquid cosmetic composition that may be held in the reservoir.

In a second aspect of the present invention there is provided a method of applying a liquid cosmetic composition to the human body, said method comprising moving across the body surface a device comprising a porous polymeric applicator head, an absorbent material fixed in intimate contact therewith, and a reservoir for the liquid cosmetic composition of total capacity for the liquid cosmetic composition greater than that of the absorbent material for the liquid cosmetic composition, the liquid cosmetic composition being transferred from the reservoir to the absorbent material and, from there, onward to the body surface via the porous polymeric applicator head.

Throughout this specification, references to application to the human body should be understood to include application to both skin and hair. The products and methods of the present invention are particularly suited for application to the human skin.

The present invention represents a significant improvement upon previously known applicators for liquid cosmetic compositions. The invention involves a porous polymeric applicator head and an absorbent material fixed in intimate contact therewith. However, we have discovered a technical problem with the use of the absorbent material: such material results in a certain amount of liquid composition being retained within the absorbent material as a residue that cannot be dispensed. In order to alleviate this problem, the device according to the present invention additionally comprises a reservoir for holding the liquid cosmetic composition, the total capacity of the reservoir for the liquid cosmetic composition being greater than the total capacity of the absorbent material for the liquid cosmetic composition. This combination of components gives the aforementioned advantages of having an absorbent material present and also gives the advantage of reducing the amount of absorbent material actually used. Reducing the amount of absorbent material present has economic and environmental benefits both in terms of the absorbent material itself and in terms of the residue retained by the absorbent material. Reducing the amount of residual liquid cosmetic composition retained by the device is a benefit that consumers particularly desire.

Throughout this specification references to total capacity should be understood to refer to the maximum weight of the liquid cosmetic composition that can be held by the element referred to.

Products according to the present invention have particularly good sensory properties in use. Consumers find that the unique combination of features present in the products results in pleasurable feelings on transfer of the composition to the human body. In particular, the product is easy to use, applies the composition smoothly and, after application, minimises the feeling of stickiness on the body surface and maximises the feeling of comfort.

Products according to the present invention are also able to achieve a consistent flow of liquid cosmetic composition through the applicator device. Consistent flow means that liquid cosmetic composition can be delivered to the body surface without interruption. Over-application, with consequential sensory negatives, is also avoided by use of products according to the present invention—there being a beneficial regulation of the flow of the liquid cosmetic composition. The above delivery benefits may be enhanced by the delivery of the liquid cosmetic composition from the absorbent material and through the porous polymeric applicator head being entirely the result of wicking. In such application, the liquid cosmetic composition that is removed from the top surface of the applicator by contact with the body surface is replaced by liquid cosmetic composition present in the absorbent material, said liquid being drawn from the absorbent material and through the porous polymeric applicator head entirely by wicking. The liquid cosmetic composition may also transfer from the liquid reservoir to the absorbent material by wicking.

A further benefit that can result from certain embodiments of the present invention is the ability to deliver a “unit dose” of the composition equal the amount of composition absorbed by the absorbent material and porous polymeric applicator, less the residue retained by the same. This may be achieved by holding or storing the device in an orientation such that liquid composition in the reservoir is in contact with the absorbent material and then re-orientating the device to an application orientation in which the liquid composition in the reservoir is not in contact with the absorbent material.

Devices that are able to deliver a “unit dose” of the composition, as described above, have contact between the liquid composition in the reservoir and the absorbent material that is orientation dependent. Such devices do not have a means for maintaining contact between the liquid composition in the reservoir and the absorbent material when the product is in use.

In a particular embodiment of the invention, the porous polymeric applicator head is at the top of the device, with the absorbent material in intimate contact immediately beneath, and the reservoir for the liquid composition immediately beneath the absorbent material. In such a device, the applicator head and absorbent material may be loaded with the liquid composition by holding or storing the device in an inverted position prior to use and then applying the composition with the device orientated so that the applicator head is at the top. Having the liquid composition in the reservoir separated from the absorbent material during use, but not during storage, is a means of achieving orientation dependent contact between the liquid composition in the reservoir and the absorbent material—“unit dose” delivery may thus be achieved.

Throughout this specification, references to the “top” and “bottom”, etc., relate to the device in its predominant in-use orientation.

In a further embodiment of the invention, the device comprises a means for maintaining contact between the liquid composition in the reservoir and the absorbent material independent of the orientation of the product. Such an embodiment enables continuous delivery of the liquid, composition to the applicator head, via the absorbent means, during application, independent of the orientation of the device. Suitable means include one or more wick-like extensions to the absorbent material that extend to the bottom of the reservoir for the liquid composition. Such one or more wick-like extensions are part of the absorbent material; indeed, the absorbent material may comprise only such one or more wick-like extensions. It is preferred that surface area of the absorbent material making contact with the porous applicator head is greater than the maximum total cross-sectional area of such one or more wick-like extensions, when present. This can enhance transfer of the liquid cosmetic composition from the absorbent material to the applicator head and thus assure sufficient rate of delivery through the device as a whole.

When present, the one or more wick-like extensions may be centrally located at the top of the absorbent material or may extend from the periphery of a top part of the absorbent material. Preferably, the one or more wick-like extensions extend to the periphery of the bottom of the reservoir, thereby reducing residual composition left within the reservoir.

The contact between the porous polymeric applicator head and the absorbent material needs to be intimate. By this, it is meant that there is physical contact between these components. To enhance transfer of the liquid cosmetic composition from the absorbent material to the applicator head and thus assure sufficient rate of delivery through the device as a whole, it is preferred that 10% or greater of an inner or lower surface of the applicator head is in intimate contact with the absorbent material. It is particularly preferred that 25% or greater, and especially preferred that 50% or greater, of an inner or lower surface of the applicator head is in intimate contact with the absorbent material. Having extents of intimate contact as indicated above may also help minimise retained liquid cosmetic composition residues.

The porous polymeric applicator head is typically made of a non-flexible, non-deformable, sintered material. Suitable materials are porous synthetic resins having omni-directional interconnecting pores, optionally formed from aggregates of united polymer particles. The material may be high-density polyethylene, low-density polyethylene, ultra-high molecular weight polyethylene, polypropylene, or polyvinylidene fluoride. A suitable commercial product is “Porex™”, available from Porex Technologies Inc. The pore size of the applicator head is typically from 1 to 200 microns, in particular from 10 to 100 microns, and especially from 25 to 75 microns.

It is preferred that the outer face of the applicator head is domed, in order to enhance the comfort in use of the product.

The absorbent material fixed in intimate contact with the porous polymeric applicator head is believed to transfer the liquid composition through to the applicator head by capillary flow or wicking. The contact is generally between an inner or lower surface of the applicator head and an outer or upper surface of the absorbent material. The contact may be between predominantly flat surfaces or the surfaces may be uneven; in the latter case, it is preferred that the unevenness in the surfaces mirror one another such that intimate contact between the surfaces is enabled across predominantly all of relevant surface areas. This latter feature of the surfaces may be of help during manufacture of the device, aiding the location of the applicator head relative to the absorbent material. A particular embodiment is ridges in the outer surface of the absorbent material and corresponding hollows in the inner surface of the applicator head.

The absorbent material serves to regulate the flow of the liquid cosmetic composition from the reservoir to the porous polymeric applicator head. The liquid cosmetic composition is typically delivered directly to the absorbent material; the absorbent material typically being able to directly contact liquid in the reservoir. The liquid absorbed by the absorbent material may pass into the applicator head by capillarity.

The absorbent material may be any material that is capable of absorbing the liquid composition to be applied and allowing its wicking through to the applicator head. Fibrous materials or open foams are suitable. Particularly suitable fibrous materials have a fibre density of from 40% to 60% by volume. Examples of suitable materials include cellulose acetate, polyester, cotton, rayon, and nylon. A suitable commercial product is PT Trasorb, available from Filtrona International Ltd. Suitable open foam materials include polyether and polyester foams, in particular, materials having from 60 to 90 pores per linear inch (152 to 229 pores per linear cm) and/or a compressibility of down to from one ninth to one quarter its original size).

The absorbent material needs to have a certain “gram-for-gram holding capacity” for the liquid composition. This may be defined as the maximum amount of liquid composition that can be held by one gram of absorbent material under standard conditions of pressure and temperature (i.e. 1 atmosphere and 25° C.). It is preferred that the holding capacity of the absorbent material is greater than the analogously defined holding capacity of the porous polymeric applicator head, the transfer of the liquid cosmetic composition through to the body surface being thereby enhanced.

In absolute terms, the holding capacity of the absorbent material is preferably 1.0 g/g or greater, more preferably 2.0 g/g or greater, and most preferably 3.0 g/g or greater, where the figures refer to grams of liquid cosmetic composition held per gram of dry absorbent material.

In order to further enhance the transfer of the liquid cosmetic composition through to the body surface, it is preferred that the total capacity of the absorbent material for the liquid cosmetic composition is greater than the total capacity of the porous polymeric applicator head for the liquid cosmetic composition. It is further preferred if the holding capacity of the porous polymeric applicator head is greater than twice that of the porous polymeric applicator head.

The total capacity of the absorbent material for the liquid cosmetic composition is less than the amount of liquid cosmetic composition that may be held in the reservoir. In order to further minimise retention of liquid cosmetic composition within the absorbent material, it is preferred that the total capacity of the absorbent material for the liquid cosmetic composition is less than half the amount of liquid cosmetic composition that may be held in the reservoir.

In devices lacking a means for maintaining contact between the liquid composition in the reservoir and the absorbent material when the product is in use, it is important that the total capacity of the absorbent material for the liquid cosmetic composition is sufficient for the desired dose of product to be delivered. When a particular “unit dose” is desired from such a product, the total capacity of the absorbent material should be chosen accordingly. Such a total capacity may be from 1 g to 100 g, in particular from 2 g to 50 g, and, especially for products intended for use on the human skin, from 2 g to 5 g.

The reservoir for the liquid cosmetic composition is a contained space for holding the composition. The contained space excludes the absorbent material. It is essential that there is a means for the composition to be delivered from the reservoir to the absorbent material. In a typical embodiment of the invention, this means is provided by having a lower face of the absorbent material as the upper boundary of the reservoir. In this typical embodiment, the reservoir may be defined by said lower face of the absorbent material together with a sidewall and a base. Said base may be concave on its inner surface; this can lead to enhanced transfer of the liquid composition to the absorbent material in embodiments comprising a centrally located wick-like extension (vide supra).

In general use, the device may be held by the consumer in the region of the sidewall that partially defines the reservoir. It is preferred that the outer cross-section of this region of the device is designed for easy handling by the consumer. Suitable cross-sectional shapes include a circle and an ellipse.

It is highly preferred that the absorbent material has a sidewall around its periphery in order to avoid possible contact between the periphery of the absorbent material and the user's body. Such contact may be perceived as less pleasing than contact with the porous polymeric applicator head. This sidewall may be continuous with the container wall or a sidewall of the reservoir.

In certain embodiments, the containing walls of the reservoir may be flexible, thereby enabling the liquid cosmetic composition within the reservoir to be put under pressure by the user squeezing the containing walls, in particular squeezing a sidewall of the reservoir. This may enhance delivery of the liquid cosmetic composition.

The containing walls of the reservoir and the sidewall around the absorbent material, when present, may be made from a material impervious to the fluid to be dispensed. Typical materials are plastics, such as polyolefins like polypropylene or polyethylene or addition copolymers, such as nylon or PET/POET.

In certain embodiments, the reservoir takes the form of a collapsible bag. Such embodiments may have the advantage that venting of the reservoir is not necessary (vide infra).

A vent giving the absorbent material and/or the reservoir access to the atmosphere is a preferred feature of devices as described in the present invention. The vent may serve to relieve pressure changes within the device caused by changes in the surrounding temperature or atmospheric pressure. Excess pressure may be relieved by a vent in a sidewall or base of the reservoir; examples of such vents include pressure-sensitive one-way valves and gas permeable membranes. When a sidewall is present that surrounds all of the otherwise exposed absorbent material, the device preferably comprises a vent giving direct access of the absorbent material to the atmosphere. The vent may be present in the sidewall around the absorbent material or it may result from the porous polymeric applicator head not completely covering the upper face of the absorbent material. The vent can serve to alleviate any build up of negative pressure within device, such as may otherwise occur during product application and be detrimental there to.

A cap for covering the applicator head is a desired additional feature of the device. Such a cap can prevent accidental contact with the applicator head and reduce the loss of any volatile components from the composition within the pores of the applicator head. The cap preferably contacts the sidewall around the absorbent material. The cap may be hinged onto said sidewall or may be fully removable. A fully removable cap may be held onto said sidewall by a screw-thread or a simply by friction between the inner surface of a sidewall of the cap and the outer surface of the absorbent material or a sidewall around it, for example a snap fit. When a vent, as previously described, is present the cap may cover the vent. Preferably, the cap does not form an air-tight seal over the applicator head; this may be achieved by having a vent present in the cap itself.

The cosmetic composition is a liquid at standard conditions of pressure and temperature. The liquid cosmetic composition may be of any type; for example, it may be a hair care product, a perfume, a deodorant, or an antiperspirant. Deodorant or antiperspirant compositions are particularly suitable. The components typically present in such compositions may be included in compositions for use in the present invention.

It is highly preferred that the composition does not comprise solid particulates larger in size than the pores of the porous polymeric applicator head. Such particulates can lead to blockage of the pores in the applicator head and/or detract from the sensory performance of the product. More preferably, the composition does not comprise any solid particulate material, for the same reasons. In preferred embodiments, the pore size of the porous polymeric applicator head is 10 microns or greater, and the composition does not comprise any particulates that are 10 microns or greater in size.

The liquid cosmetic composition frequently comprises a liquid carrier fluid; for example, a C2 to C4 alcohol like ethanol, propylene glycol, propanol, or iso-propanol. Such compositions can give particularly good sensory properties when applied according to the present invention. Suitable liquid compositions typically comprise C2 to C4 alcohol at a level of from 5% to 95%, in particular from 25% to 80%, and especially from 40% to 75% by weight of the composition. Liquid compositions comprising ethanol are particularly suitable.

The liquid carrier fluid may also comprise water; for example, in an amount from 0.1% to 60% by weight of the composition. Compositions comprising water and a C2 to C4 alcohol, in particular ethanol, are especially preferred.

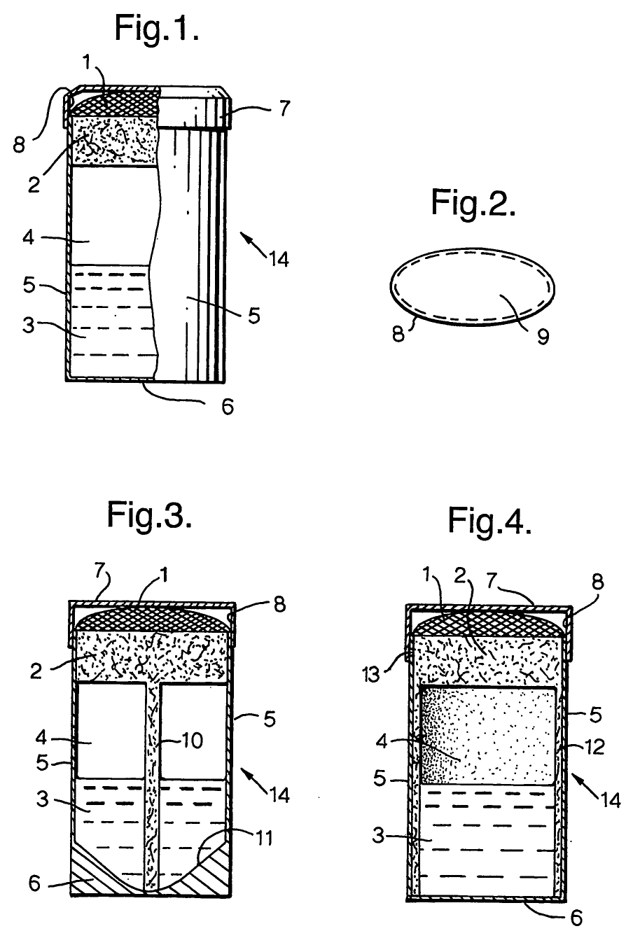

The invention will now be further disclosed by means of specific, non-limiting, embodiments, with reference to FIGS. 1 to 4.

FIG. 1 represents a vertical central cross-section through a product according the invention wherein contact between the liquid composition (3) in the reservoir (4) and the absorbent material (2) is orientation dependent.

FIG. 2 represents a top perspective of the embodiment illustrated in FIG. 1, 3, or 4.

FIGS. 3 and 4 represent vertical central cross-sections through products according the invention wherein different types of wick-like extension (10, 12) to the absorbent material (2) extend to the bottom of the reservoir (4) for the liquid composition (3) and serve as means for maintaining contact between the liquid composition (3) in the reservoir (4) and the absorbent material (2).

In FIGS. 1, 3 and 4, the porous polymeric applicator head (1) is at the top of the device (14) and is fixed in intimate contact with absorbent material (2), immediately below. The liquid cosmetic composition (3) is held within a reservoir (4) below the absorbent material (2). The reservoir (4) is defined by the bottom of the absorbent material (2), a sidewall (5), and a base (6). The sidewall (5) extends upwards and also encloses absorbent material (2). The applicator head is covered by a cap (7). The top of the sidewall (5) forms a releasable seal with the sidewall (8) of the cap (7), the cap (7) being releasably held on by friction fit.

FIG. 2 illustrates the elliptical cross-section (9) of this embodiment and the sidewall of the cap (8). FIG. 3 illustrates an embodiment having a central wick-like extension (10) to the absorbent material (2) extending to the base of the reservoir (6), which is concave on its inner surface (11).

FIG. 4 illustrates an embodiment having a peripheral wick-like extension (12) to the absorbent material (2) extending to the bottom of the reservoir (6). Whilst not apparent from FIG. 4, this extension extends around the entire periphery of the reservoir (4). Also illustrated is a vent (13) in the sidewall (5) enclosing the absorbent material (2). The vent (13) is covered by the sidewall (8) of the removable cap (7).

1. A product comprising a liquid cosmetic composition (3) and a device (14) for applying the same, said device (14) comprising a porous polymeric applicator head (1), an absorbent material (2) fixed in intimate contact therewith, and a reservoir (4) for the liquid cosmetic composition (3) from which said composition is delivered to the absorbent material (2), characterised in that the total capacity of the absorbent material (2) for the liquid cosmetic composition (3) is less than the amount of liquid cosmetic composition (3) that may be held in the reservoir (4).

2. A product according to claim 1, wherein contact between the liquid composition (3) in the reservoir (4) and the absorbent material (2) is orientation dependent.

3. A product according to claim 1, comprising a means for maintaining contact between the liquid composition (3) in the reservoir (4) and the absorbent material (2) independent of the orientation of the product.

4. A product according to claim 3, wherein the means for maintaining contact between the liquid composition (3) in the reservoir (4) and the absorbent material (2) comprises a wick-like extension (10, 12) to the absorbent material (2) that extends to the bottom of the reservoir (4) for the liquid composition (3).

5. A product according to claim 4, wherein the surface area of the absorbent material (2) making contact with the porous applicator head (1) is greater than the maximum total cross-sectional area of the one or more wick-like extensions (10, 12).

6. A product according to claim 1, wherein 10% or greater of an inner or lower surface of the applicator head (1) is in intimate contact with the absorbent material (2).

7. A product according to claim 6, wherein 50% or greater of an inner or lower surface of the applicator head (1) is in intimate contact with the absorbent material (2).

8. A product according to claim 1, wherein the applicator head (1) is made of a non-flexible, non-deformable, sintered material.

9. A product according to claim 1, wherein the outer face of the applicator head (1) is domed.

10. A product according to claim 1, wherein absorbent material (2) is a fibrous material or open foam.

11. A product according to claim 1, wherein absorbent material (2) has a gram-for-gram holding capacity for the liquid composition (3) that is greater than the gram-for-gram holding capacity of the porous polymeric applicator head (1).

12. A product according to claim 1, wherein the absorbent material (2) has a total capacity for the liquid composition (3) that is greater than the total capacity of the porous polymeric applicator head (1) for the liquid composition (3).

13. A product according to claim 1, wherein the absorbent material (2) has a total capacity for the liquid composition (3) that is less than half the amount of liquid cosmetic composition that may be held in the reservoir (4).

14. A product according to claim 1, wherein the reservoir (4) takes the form of a collapsible bag.

15. A product according to claim 1, comprising a vent (13) giving the absorbent material (2) and/or the reservoir (4) access to the atmosphere.

16. A method of applying a liquid cosmetic composition (3) to the human body, said method comprising moving across the body surface a device (14) comprising a porous polymeric applicator head (1), an absorbent material (2) fixed in intimate contact therewith, and a reservoir (4) for the liquid cosmetic composition (3) of total capacity for the liquid cosmetic composition (3) greater than that of the absorbent material (2) for the liquid cosmetic composition (3), the liquid cosmetic composition (3) being transferred from the reservoir (4) to the absorbent material (2) and, from there, onward to the body surface via the porous polymeric applicator head (1).

17. A method according to claim 16, wherein the delivery of the liquid cosmetic composition (3) from the absorbent material (2) and through the porous polymeric applicator head (1) is entirely the result of wicking.
